(19) United States
(12) Patent Application Publication
(10) Pub. No.: US 2017/0006891 A1
(43) Pub. Date: Jan. 12, 2017

(54) METHOD OF MANUFACTURING LIQUID FOOD/BEVERAGE AND LIQUID FOOD/BEVERAGE MANUFACTURED USING THE METHOD

(71) Applicant: ITO EN, LTD., Tokyo (JP)

(72) Inventors: Masataka SAKATA, Makinohara-shi (JP); Tatsuya KONISHI, Tokyo (JP); Masami SASAME, Makinohara-shi (JP)

(21) Appl. No.: 15/113,068

(22) PCT Filed: Dec. 26, 2014
(86) PCT No.: PCT/JP2014/006504

§ 371 Date: Jul. 21, 2016

(30) Foreign Application Priority Data
Apr. 30, 2014 (JP) 2014-094196

(51) Int. Cl. A23F 3/16; A23L 2/46; A23L 2/04

(52) U.S. Cl. CPC A23F 3/163; A23L 2/04; A23L 2/46; A23V 2002/00

(57) ABSTRACT

A method of manufacturing a liquid food/beverage packed in a container obtained by diluting a raw material liquid with a diluting liquid having a lower viscosity than that of the raw material liquid includes: a diluting liquid heating step of heating the diluting liquid up to a higher temperature than that of the raw material liquid before being mixed with the raw material liquid; a primary heating/diluting step of swirling the diluting liquid in the raw material liquid to generate a swirl flow thereby to dilute the raw material liquid while heating the raw material liquid through heat convection of the swirl flow; and a secondary heating/sterilizing step of, after the primary heating/diluting step, heating and sterilizing a mixed liquid of the raw material liquid and the diluting liquid by conductive heat.

### TECHNICAL FIELD

The present invention relates to a method of manufacturing a liquid food/beverage, and particularly to a method of manufacturing a liquid food/beverage that has flowability and is obtained by mixing liquid materials having different viscosities.

### BACKGROUND ART

With the progress of an aging society in recent years, elderly people who are difficult to intake ordinary food are on the increase.

In general, swallowing function or ability to swallow food becomes poor with age.

As swallowing becomes difficult, not only intake of solids will be difficult, but swallowing of ordinary liquid such as soft drink will also be severe.

If, in such a situation, food/beverage accidentally enters an airway due to aspiration, the food/beverage may not be coughed up because the muscle is weakened with age. This may result in symptoms such as so-called aspiration pneumonitis, which will put lives at risk in some instances. Therefore, close attention must be paid when people who are difficult in swallowing intake food/beverage.

In order that even such people who are difficult in swallowing can easily intake food/beverage, there has been provided a liquid food/beverage which has a certain viscosity while having flowability and which can be swallowed at once without lodging in the throat.

Examples of such food/beverage include: jellied (gelled) food/beverage; beverage obtained by providing soft drink with a higher viscosity than those of ordinary beverages, the soft drink exemplified by tea-based beverage such as green tea and red or black tea, coffee beverage and fruit juice drink; and liquid food for people who are difficult in swallowing, such as potage soup, arrowroot starch gruel (“Kuzuyu”), drinkable yogurt, curry, and stew.

For example, people of mature age and more elderly people prefer to drink tea beverage such as green tea, but as the swallowing ability becomes poor as described above, ordinary green tea beverage will be difficult to drink, so that desire to have favorite beverage may not be fulfilled. Accordingly, even for soft drink such as tea beverage, there has been a large demand for products that are directed to people who are difficult in swallowing.

The liquid food/beverage as described above may preferably be provided as a liquid food/beverage packed in a container in an RTD (ready-to-drink) form. However, since the liquid food/beverage packed in a container is expected to be stored for a long period of time, it is important to suppress as much as possible the so-called time degradation, i.e., degradation in the taste and flavor of the content during the storage, thereby to maintain high quality.

In the manufacturing steps, therefore, it is required to suppress the oxidation and deterioration of sugar and amino acid which may cause the time degradation and also to suppress the variation and ununiformity of the concentration and composition of the liquid food/beverage as the content.

A conventional method of manufacturing soft drink packed in a container, such as tea-based beverage, fruit juice drink and milk beverage, will be described as one example of a method of manufacturing a liquid food/beverage packed in a container.

Such soft drink packed in a container is manufactured by adding a diluting liquid such as water to dilute a raw material liquid having a high concentration and a high viscosity, e.g., a concentrate of a plant body extracted liquid such as green tea and red or black tea, a concentrated fruit juice, or concentrated milk.

In a commonly-used method, the mixed liquid of the raw material liquid and the diluting liquid is heated and sterilized at a predetermined temperature for a certain period of time while being stirred, and thereafter packed in a given container, such as a PET bottle and a can.

A specific example will then be described with reference to a case of tea beverage packed in a container.

First, extraction from tea leaves is performed in hot water and the extracted liquid is concentrated to a certain concentration, and a raw material liquid of high concentration/high viscosity is thus obtained. After being cooled once, the raw material liquid is blended with a pH adjuster, an antioxidant and other additives, and then diluted to a predetermined concentration using a diluting liquid such as water.

Subsequently, the mixed liquid obtained by diluting the raw material liquid is heated to a predetermined sterilization temperature while being stirred and held for a certain period of time for sterilization, and the dissolved oxygen in the mixed liquid is degassed.

The mixed liquid is then cooled before being filled into and packed in a given container. The procedure is thus completed.

Even to other liquid food/beverage than the tea-based beverage, the manufacturing steps can be applied with little modification, i.e., steps of “preparing a raw material liquid of a high concentration and a high viscosity;” “then diluting the raw material liquid with a diluting liquid such as water to a predetermined concentration;” and “performing sterilization and degassing.”

If the manufacturing steps are applied to the food/beverage for people who are difficult in swelling as described above, the raw material liquid may be prepared to have a preferred viscosity by adding a thickener such as pectin or other appropriate additives at the stage of the raw material liquid or at any stage after the diluting step.

Besides the above-described tea extracted liquid, the raw material liquid of soft drink such as fruit juice, vegetable juice and condensed milk may sometimes be traded in a form of being condensed to a high concentration for the purpose of improving the efficiency in distribution and other purposes.

In particular, in the case of liquid food/beverage for people who are difficult in swelling, the mixed liquid of the raw material liquid and the diluting liquid also has a higher viscosity and a higher density than those of water.

The raw material liquid and the diluting liquid are put into a large tank such as batch tank with a predetermined mass ratio so that concentration adjustment is performed, and the mixed liquid is thereafter heated to a sterilization temperature using a heating apparatus such as heater for heating the batch tank and held at the sterilization temperature for a certain period of time for sterilization.

When the viscosity of the mixed liquid is high, the mixed liquid may have to be sufficiently stirred using a stirrer in order to make the heating state and the concentration uniform.

In particular, when the raw material liquid has a high concentration and the viscosity of the mixed liquid is also high, particularly strong stirring may be required for uniform concentration and temperature. This may lead to a problem in that air is incorporated due to stirring thereby to increase the dissolved oxygen in the mixed liquid, which will cause time degradation thereafter.

In addition, heating for sterilization and degassing is usually performed by directly heating a tank such as batch tank, as previously described. In this case, a large amount of the mixed liquid may have to be heated from a cool temperature state to the sterilization temperature.

Accordingly, the period of time for achieving the sterilization temperature or so-called come-up time is prolonged, and if the viscosity of the mixed liquid is high, a part of the mixed liquid tends to be excessively heated due to ununiform heating, so that the contained amino acid or the like may be caused to thermally denature. This may not only cause the time degradation during the storage but also lead to problems in that the flavor and the taste balance are likely to collapse and that the thermal energy for heating increases, which may be undesirable in view of energy cost.

A variety of methods of manufacturing have ever been proposed for the purpose of quality preservation of ordinary soft drink (Patent Literature 1 to Patent Literature 7).

Patent Literature 1 and Patent Literature 2 propose methods in which the raw material, the packing container and the like are placed in a nitrogen gas atmosphere during the manufacturing steps.

However, while such methods can prevent oxygen from newly dissolving, the drink liquid itself to be packed cannot be degassed (oxygen cannot be removed), and the above-described problems may not be solved.

Patent Literature 3 and Patent Literature 4 propose methods in which the dissolved oxygen in the drink liquid is forcibly removed in a reduced pressure environment using a deaerator (degassing apparatus).

However, flavor components other than oxygen may also be removed from the drink liquid because forcible degassing (oxygen removal) is performed in the reduced pressure environment. This may lead to a problem in that such methods are hard to be applied to soft drink, such as tea beverage and coffee beverage, in which flavor components are extremely important.

Patent Literature 5 discloses a method in which degassed water is used as the diluting liquid. However, this method is similar to the above prior art in an aspect that the mixed liquid is directly heated from a cooled temperature state. Therefore, the time degradation of the drink liquid cannot be sufficiently suppressed, and the problem of energy cost may not be solved.

In addition to the above, there are proposed various methods for reducing the dissolved oxygen in the drink liquid, including a method in which a hollow-fiber membrane is used to perform filtration (Patent Literature 6) and a method in which a means is provided to attach an oxygen removing agent, which absorbs water thereby to exert action/effect of oxygen removal, to the inner surface of a cap of a container to be filled with the drink liquid (Patent Literature 7).

When the hollow-fiber membrane is used, however, an additional installation cost will be necessary and thus problematic. It is also undesirable that the oxygen removing agent is disposed at a part to be in direct contact with the beverage, and the container cost will increase, which will also be problematic.

As described above, the methods as proposed in the prior art are all insufficient in view of preventing the time degradation of the drink liquid and reducing the energy cost in the manufacturing steps.
[Patent Literature 1] JP3457566B
[Patent Literature 2] JP4135061B
[Patent Literature 3] JP4988477B
[Patent Literature 4] JP2009-17864A
[Patent Literature 5] JP6-141825A
[Patent Literature 6] JP2005-110527 A
[Patent Literature 7] JP4408142B

### DISCLOSURE OF THE INVENTION

### Problems to be solved by the Invention

In view of the previously-described background, an object of the present invention is to provide a liquid food/beverage which can suppress so-called time degradation during the storage, such as generation of degradation odor, change in liquid color and generation of precipitation or sediment, can maintain good flavor and taste, and can reduce the energy cost in the manufacturing steps. Another object of the present invention is to provide a method of manufacturing such a liquid food/beverage.

### Means for Solving the Problems

To solve the above problems, the present invention is configured as follows:

(1)

A method of manufacturing a liquid food/beverage obtained by diluting a raw material liquid with a diluting liquid having a lower viscosity than that of the raw material liquid, the method being characterized by comprising: a diluting liquid heating step of heating the diluting liquid up to a higher temperature than that of the raw material liquid before being mixed with the raw material liquid; a primary heating/diluting step of swirling the diluting liquid in the raw material liquid to generate a swirl flow thereby to dilute the raw material liquid while heating the raw material liquid through heat convection of the swirl flow; and a secondary heating/sterilizing step of, after the primary heating/diluting step, heating and sterilizing a mixed liquid of the raw material liquid and the diluting liquid by conductive heat.

(2)

The method of manufacturing a liquid food/beverage as described in 1, characterized in that the mixed liquid of the raw material liquid and the diluting liquid in the primary heating/diluting step has a viscosity within a range of 0.33 to 490 mPa*s.

(3)

The method of manufacturing a liquid food/beverage as described in 1 or 2, characterized in that the raw material liquid is heated within a range of 45° C. to 95° C. in the primary heating/diluting step.

(4)

The method of manufacturing a liquid food/beverage as described in any one of 1 to 3, characterized in that a sterilizing temperature in the secondary heating/sterilizing step is within a range of 125° C. to 140° C.

(5)

The method of manufacturing a liquid food/beverage as described in any one of 1 to 4, characterized in that the raw material liquid and the diluting liquid are mixed at a constant mass ratio in the primary heating/diluting step.

(6)

The method of manufacturing a liquid food/beverage as described in any one of 1 to 5, characterized in that the raw material liquid contains an extract from a plant body.

(7)

The method of manufacturing a liquid food/beverage as described in any one of 1 to 6, characterized in that the plant body comprises tea leaves.

(8)

A liquid food/beverage manufactured by the method of manufacturing as described in any one of 1 to 7.

(9)

The liquid food/beverage as described in 8, characterized in that the liquid food/beverage comprises a green tea beverage.

(10)

A method of preventing time degradation of a liquid food/beverage obtained by diluting a raw material liquid with a diluting liquid having a lower viscosity than that of the raw material liquid, the method being characterized by comprising: a diluting liquid heating step of heating the diluting liquid up to a higher temperature than that of the raw material liquid before being mixed with the raw material liquid; a primary heating/diluting step of swirling the diluting liquid in the raw material liquid to generate a swirl flow thereby to dilute the raw material liquid while heating the raw material liquid through heat convection of the swirl flow; and a secondary heating/sterilizing step of, after the primary heating/diluting step, heating and sterilizing a mixed liquid of the raw material liquid and the diluting liquid.

### Advantageous Effect of the Invention

When the raw material liquid is diluted with the diluting liquid, the diluting liquid generates a swirl flow. Therefore, strong heat convection occurs in the mixed liquid of the diluting liquid and the raw material liquid, so that the heat of the diluting liquid is rapidly conducted to the raw material liquid through the heat convection. The swirl flow also allows the raw material liquid and the diluting liquid to readily be mixed with each other uniformly.

Accordingly, even when the viscosity of the raw material is high, the raw material can be uniformly heated and diluted, and ununiform heating and concentration hardly occur. According to the method of manufacturing of the present invention, therefore, even in the liquid food/beverage provided such that the viscosity is increased for people who are difficult in swallowing, oxidation and degradation of the components due to excessive heating in the manufacturing steps are unlikely to occur, and the flavor and taste will be maintained in a good state. The time degradation can thus be preferably suppressed.

In the secondary heating/sterilizing step, a tank such as batch tank which stores the mixed liquid of the raw material liquid and the diluting liquid is heated by an external heat source, so that the mixed liquid is heated via the heat conduction through the material of the tank.

As described above, since the mixed liquid of the raw material liquid and the diluting liquid is preliminarily heated in the primary heating/diluting step, the period of time for achieving the sterilization temperature (so-called come-up time) can be shortened in the secondary heating/sterilizing step thereby to suppress the cost of thermal energy necessary for the secondary heating/sterilizing.

There has also been obtained a knowledge that high-temperature and short-time heating via heat conduction in the secondary heating/sterilizing step can effectively act for the flavor formation of the liquid food/beverage.

According to the above, there can be provided a method of manufacturing a liquid food/beverage which can suppress so-called time degradation during the storage of the liquid food/beverage, such as generation of degradation odor, change in liquid color and generation of precipitation or sediment, can maintain good flavor and taste, and can reduce the energy cost in the manufacturing steps. There can also be provided a liquid food/beverage manufactured using the method.

### Best Mode for Carrying Out the Invention

Embodiments for carrying out the present invention will hereinafter be described with reference to a case where the liquid food/beverage is green tea.

Any known approach in the art other than the embodiments described below may be appropriately selected without departing from the technical scope of the present invention.

### 1. Raw Material for Raw Material Liquid

The raw material liquid in the present embodiment may contain an extract from a plant body. When the extract is liquid, the extract can be used without any modification.

The extract may also be used in a form of being concentrated, or dried to solids and dissolved again in a solvent, such as water, to be used.

One or more kinds of raw material liquids can be used as necessary.

The raw material liquid can contain some additives to be described later in addition to the extract of a plant body.

### 2. Plant Body

The plant body as used in the present application may preferably be selected, for example, from tea leaves and cereals such as barley or the like, black bean and rice, and may also be selected from other plants if the contained components can be extracted such as by immersing the plant into some extraction solvent.

Constituent parts of the plant body, such as leave, twig, root, seed and petal, are not particularly limited.

The extraction method can be selected from known approaches in the art, such as a method of simply immersing the plant body into an extraction solvent. The extraction solvent can be selected from hot water and cold water as well as some organic solvent, but water is preferred as the extraction solvent because it is used for beverage.

If necessary, suitable processes such as compression, filtration and centrifugal separation may be performed at the time of extraction.

The extract of a plant body as used in the present embodiment may be in a state where the contained components of the plant body are extracted into the extraction solvent, or may further be concentrated or dried as necessary to obtain the extracted components as solids.

If necessary, the plant body may also be in a form of a processed product of the plant body obtained through steps, such as cutting, heating and drying.

The plant body will be further described with reference to an example of a case in which the plant body comprises tea leaves.

When tea leaves is selected as the plant body, a plant variety of the tea leaves is not particularly limited if the method of manufacturing a beverage packed in a container as in the present application can be applied thereto, but a tea plant (Camellia sinensis) may preferably be selected, for example.

When the plant body comprises tea leaves, the tea leaves may be fresh tea leaves. When the tea leaves are used as a processed product of the plant body, it may also be possible to use: unrefined tea (“Aracha”) processed through so-called unrefined tea processing steps including a step of heating fresh leaves such as by steaming and roasting and a step of rolling; produced tea (“Seicha”) (finished tea (“Shiagecha”)), such as decocted tea (“Sencha”) and refined tea or Jade Dew (“Gyokuro”), obtained by further processing the unrefined tea for finishing; half-fermented tea such as oolong tea; and fermented tea such as red or black tea.

When the plant body is barley or the like, it may be in a state of roasted barley or the like. Two or more kinds thereof may also be blended to be used. The previously described fresh tea leaves may also be used after being processed for crushing and cutting without heating.

### 3. Raw Material Liquid

In the present embodiment, when the extract is liquid, the extract can be used as the raw material liquid without any modification. The extract may also be used in a form of being concentrated, or dried to solids and dissolved again in a solvent, such as water, to be used.

One or more kinds of raw material liquids can be used as necessary.

The raw material liquid can contain some additives to be described later in addition to the extract of a plant body.

### 4. Diluting Liquid

In the present embodiment, water is preferred as the diluting liquid. In particular, it is preferred to contain degassed water which is preliminarily subjected to a degassing process to remove the dissolved oxygen. Known means in the art can be used as the degassing method for the diluting liquid, such as degassing through heating and degassing by using a deaerator.

When degassed water is used as water, the degassed water can be mixed with the raw material liquid thereby to reduce the amount of dissolved oxygen in the mixed liquid in the primary heating/diluting step.

The adjustment of the amount of dissolved oxygen can be performed by substituting a part of water to be mixed to the raw material liquid with pure water that is not subjected to degassing process. The adjustment of temperature can be performed by adjusting a preliminary heating temperature for the diluting liquid.

Since the pure water is not subjected to a particular degassing process, the ratio of the pure water may be increased thereby to adjust the amount of dissolved oxygen without varying the mixing mass ratio of the raw material liquid and water.

### (Temperature of Water)

In the present embodiment, pure water, degassed water and heated water (degassed) were used as the diluting liquid to be used in the primary heating/diluting step. Specifically, pure water adjusted to 25° C. and 7.0 ppm of dissolved oxygen, degassed water adjusted to 25° C. and 0 ppm of dissolved oxygen, and heated water adjusted to 60° C. to 98° C. and 0 ppm of dissolved oxygen, were used.

### 5. Mixed Liquid

The mixed liquid as used in the present embodiment refers to a liquid that is in a state where the raw material liquid and the diluting liquid are mixed at a certain mass ratio through the primary heating/diluting step.

In the present embodiment, the temperature of the mixed liquid may preferably be adjusted to 45° C. to 95° C., more preferably to 45° C. to 90° C., and further preferably to 45° C. to 80° C.

The amount of dissolved oxygen in the mixed liquid may preferably be adjusted to 0.1 ppm to 3.0 ppm.

The amount of dissolved oxygen may more preferably be adjusted to 0.1 ppm to 2.0 ppm, and further preferably to 0.1 ppm to 1.5 ppm.

In the primary heating/diluting step, the raw material liquid is mixed with water as the diluting liquid thereby to be heated by the heat of the heated water while being diluted. At the same time, degassed water is mixed therein, so that the adjustment of the amount of dissolved oxygen in the mixed liquid is concurrently performed.

### (Viscosity)

In the present embodiment, it is preferred that the raw material liquid has a predetermined viscosity. The viscosity of the mixed liquid of the raw material liquid and the diluting liquid may preferably be 0.33 to 490 mPa*s, more preferably 0.33 to 400 mPa*s, and further preferably 0.33 to 300 mPa*s.

If the viscosity is lower than 0.33 mPa*s or higher than 490 mPa*s, there may be a risk that people who are difficult in swallowing cannot easily drink. If the viscosity is higher than 490 mPa*s, there may be a risk that uniform diluting will be difficult even by the method according to the present application.

Note that one pascal-second represents a viscosity (Pa/((m/s)/m)=Pa*s) at which, when there is a velocity gradient of one meter per second (m/s) per one meter (m) in a fluid, a stress of one pascal (Pa) is generated in the direction of the velocity on a surface perpendicular to the direction of the velocity gradient.

### (Measurement of Viscosity)

In the present embodiment, the viscosity was measured using a Tuning Fork Vibro Viscometer SV-10 (available from A&D Company, Limited).

Water as the diluting liquid swirls in the raw material liquid to generate a swirl flow.

The method of generating a swirl flow is not limited. For example, when the primary heating/diluting step is performed in a cylindrically-shaped tank, water as the diluting liquid can be poured into the tank along the inner wall of the tank thereby to generate a swirl flow in the raw material liquid. The raw material liquid is heated through heat convection of water as the diluting liquid while being stirred by the swirl flow, so that the mixed liquid as a whole will have a uniform concentration and will be uniformly heated.

In the secondary heating/sterilizing step, therefore, the heating time for achieving the sterilization temperature can be reduced, and the ununiform concentration of the mixed liquid and the ununiform heating are unlikely to occur.

In the present embodiment, a sterilizing temperature in the secondary heating/sterilizing step may preferably be within a range of 120° C. to 145° C., more preferably of 123° C. to 140° C., further preferably of 125° C. to 140° C., and most preferably of 125° C. to 135° C.

In order for the amount of dissolved oxygen in the mixed liquid to be less than 0.1 ppm, a forcibly degassing process such as using a deaerator may have to be performed in addition to the above. In this case, however, aroma components originated from the plant body may also be lost with the dissolved oxygen. Therefore, when the flavor balance is important such as in a tea beverage, excessive degassing beyond the requirement in the present application may rather negatively affect the production quality.

It has also been obtained a knowledge that, in a tea beverage and the like, such a slight amount of oxygen remains thereby to enhance the aroma note owing to the high-temperature and short-time heating in the secondary heating/sterilizing step. Therefore, heating by heat conduction is preferred as the heating method.

### 6. Other Additives

### (Sweetener)

If necessary, the raw material liquid can contain, in addition to the thickener, one or more kinds of sweeteners selected from: sugar-based sweeteners such as sucrose, fructose, glucose and maltose; natural non-sugar sweeteners such as stevia; and artificial sweeteners such as sucralose and aspartame.

When the raw material liquid is an extracted liquid of green tea such as decocted tea, however, it is preferred not to add sugars other than those originated from the extraction object, unless if necessary.

If necessary, similar additives to those for the raw material liquid can also be added to the diluting liquid as long as the requirement is satisfied that the viscosity of the diluting liquid is lower than that of the raw material liquid.

### (Others)

Within a scope to which the present method of manufacturing can be applied, the raw material liquid can contain one or more kinds selected from amino acids such as glutamic acid, asparaginic acid, glutamine, asparagine, arginine and alanine; vitamins such as vitamin A, vitamin C and vitamin E; and polyphenols such as catechin and chlorogenic acid.

Each of the above components can be added as a separately produced agent, but may preferably be a component that is originated from the plant body as the extraction object.

7. pH

The pH of the mixed liquid can be appropriately adjusted in accordance with the type of the beverage to be manufactured. For example, when the beverage packed in a container is a green tea beverage, the pH may preferably be 3.8 to 6.5, more preferably 5.0 to 6.4, and further preferably 6.0 to 6.3.

Adjustment of the pH can be appropriately performed such as using sodium hydrogen carbonate and citric acid.

### 8 Container

In the present embodiment, the container to be filled with the beverage is not particularly limited. For example, a plastic-made bottle (so-called PET bottle), a can of metal such as steel and aluminum, a bottle, a paper container and the like can be used. In particular, a transparent container or the like, such as a PET bottle, may preferably be used as the container.

### EXAMPLES

Examples according to the present invention will hereinafter be described mainly with reference to examples in the cases where the beverage packed in a container is a green tea beverage.

### 1. Preparation of Raw Material Liquids

In the present examples, a green tea extract was used as the plant body extract to prepare each of Raw material liquids 1 to 7 based on the prescriptions as below:

### (1) Raw Material Liquid 1

Extraction for 5 minutes was performed in 2,000 ml of hot water of 90° C. using 48 g of deeply steamed first-picked tea produced in Shizuoka Prefecture.

After the extracted liquid was filtrated, 3.2 g of vitamin C and 2.4 g of sodium bicarbonate were added to the liquid and 224 g of pectin was further added. The liquid was then diluted with degassed water to 4 L using a measuring cylinder, and Raw material liquid 1 was thus obtained.

### (2) Raw Material Liquid 2

Extraction for 5 minutes was performed in 2,000 ml of hot water of 90° C. using 48 g of deeply steamed first-picked tea produced in Shizuoka Prefecture.

After the extracted liquid was filtrated, 3.2 g of vitamin C and 2.4 g of sodium bicarbonate were added to the liquid and 224 g of pectin was further added. The liquid was then concentrated to have a Brix value of 15.3, and Raw material liquid 2 was thus obtained.

### (3) Raw Material Liquid 3

Extraction for 5 minutes was performed in 2,000 ml of hot water of 90° C. using 48 g of deeply steamed first-picked tea produced in Shizuoka Prefecture.

After the extracted liquid was filtrated, 3.2 g of vitamin C and 2.4 g of sodium bicarbonate were added to the liquid and 224 g of pectin was further added. The liquid was then concentrated to have a Brix value of 42.7, and Raw material liquid 3 was thus obtained.

### (4) Raw Material Liquid 4

Extraction for 5 minutes was performed in 14,000 ml of hot water of 90° C. using 340 g of deeply steamed first-picked tea produced in Shizuoka Prefecture.

After the extracted liquid was filtrated, 22.4 g of vitamin C and 16.8 g of sodium bicarbonate were added to the liquid. The liquid was then concentrated to have a Brix value of 3.5, and Raw material liquid 4 was thus obtained.

### (5) Raw Material Liquid 5

Extraction for 5 minutes was performed in 2,000 ml of hot water of 90° C. using 48 g of deeply steamed first-picked tea produced in Shizuoka Prefecture.

After the extracted liquid was filtrated, 3.2 g of vitamin C and 2.4 g of sodium bicarbonate were added to the liquid and 265.6 g of pectin was further added. The liquid was then diluted with degassed water to 4 L using a measuring cylinder, and Raw material liquid 5 was thus obtained.

### (6) Raw Material Liquid 6

Extraction for 5 minutes was performed in 5,500 ml of hot water of 90° C. using 130 g of deeply steamed first-picked tea produced in Shizuoka Prefecture.

After the extracted liquid was filtrated, 22.4 g of vitamin C and 16.8 g of sodium bicarbonate were added to the liquid. The liquid was then concentrated to have a Brix value of 1.4, and Raw material liquid 6 was thus obtained.

### (7) Raw Material Liquid 7

Extraction for 5 minutes was performed in 2,000 ml of hot water of 90° C. using 48 g of deeply steamed first-picked tea produced in Shizuoka Prefecture.

After the extracted liquid was filtrated, 3.2 g of vitamin C and 2.4 g of sodium bicarbonate were added to the liquid and 272 g of pectin was further added. The liquid was then diluted with degassed water to 4 L using a measuring cylinder, and Raw material liquid 7 was thus obtained.

### Example 1

### Evaluation of the Method of Manufacturing According to the Present Invention

### (1) Preparation of Samples

Raw material liquid 1 was used to prepare each of Samples 1 to 6 under the conditions as listed in Table 1. A microwave oven was used for the primary heating of Sample 5.

TABLE 1

| | | Sample 1 | Sample 2 | Sample 3 | Sample 4 | Sample 5 | Sample 6 |
|---|---|---|---|---|---|---|---|
| Raw material liquid | | Raw | Raw | Raw | Raw | Raw | Raw |
| | | material | material | material | material | material | material |
| | | liquid 1 | liquid 1 | liquid 1 | liquid 1 | liquid 1 | liquid 1 |
| Bx of raw material liquid | | 6.1 | 6.1 | 6.1 | 6.1 | 6.1 | 6.1 |
| Primary heating/ | Generation of | present | absent | present | absent | present | present |
| diluting step | swirl flow | | | | | | |
| | Temperature of | 95° C. | 95° C. | 25° C. | 25° C. | 25° C. | 95° C. |
| | diluting liquid | | | | | | |
| | (heated water · | | | | | | |
| | degassed water) | | | | | | |
| | Mixing ratio | 1:1 | 1:1 | 1:1 | 1:1 | 1:1 | 1:1 |
| | (diluting liquid/ | | | | | | |
| | raw material liquid) | | | | | | |
| | Primary heating | 60° C. | 60° C. | 25° C. | 25° C. | 60° C. | 60° C. |
| | temperature (° C.) | | | | | | |
| | Bx of mixed liquid | 3.1 | 3.1 | 3.1 | 3.1 | 3.1 | 3.1 |
| | after primary heating | | | | | | |
| | Viscosity of mixed | 260 | 260 | 500 | 500 | 260 | 260 |
| | liquid (mPa · s) | | | | | | |
| Secondary heating/ | Secondary heating | 130° C. | 130° C. | 130° C. | 130° C. | 130° C. | 130° C. |
| sterilizing step | temperature (° C.) | | | | | | |
| | Method of secondary | Plate-type | Plate-type | Plate-type | Plate-type | Plate-type | Retort-type |
| | heating | sterilizer | sterilizer | sterilizer | sterilizer | sterilizer | sterilizer |

### (2) Sensory Evaluation

With regard to Samples 1 to 6 prepared under the conditions of Table 1, sensory evaluation test was performed for the evaluation items as below under the evaluation condition as presented in Table 2.

The sensory evaluation test was delegated to seven panelists and performed to evaluate each item in accordance with criteria as below:

### (Evaluation Items)

### (Top Aroma Note)

Strong: A

Strongish: B

Weakish: C

Weak: D

### (Smoothness)

Very good: A

Good: B

Baddish: C

Bad: D

### (Water Color)

Very good: A

Good: B

Baddish: C

Bad: D

Table 2 presents results of the evaluation of Samples 1 to 6 in terms of the above evaluation items.

TABLE 2

| Evaluation condition | Sensory evaluation items | Sample 1 | Sample 2 | Sample 3 | Sample 4 | Sample 5 | Sample 6 |
|---|---|---|---|---|---|---|---|
| When drunk at 23° C. | Top aroma note | B | C | C | C | C | D |
| | Smoothness | B | C | C | D | C | C |
| | Water color | B | C | D | D | C | B |

| | | | | | | |
|---|---|---|---|---|---|---|
| Comprehensive evaluation | B | C | C | D | C | C |

### (Consideration)

As apparent from the presentation in Table 2, it has been revealed that good sensory evaluation results can be obtained for the mixed liquid prepared by performing the secondary heating via conductive heat while generating a swirl flow in the primary heating/diluting step.

### Example 2

### Evaluation of Viscosity of Mixed Liquid

### (1) Preparation of Samples

Raw material liquids 1 and 4 to 7 were used to prepare Samples 1 and 7 to 10 by changing the viscosity of the raw material liquid under the conditions as listed in Table 3, and sensory evaluation test was performed for the evaluation items as below.

Table 4 presents results of the sensory evaluation. The method of the sensory evaluation test was the same as in Example 1.

TABLE 3

| | | Sample 1 | Sample 7 | Sample 8 | Sample 9 | Sample 10 |
|---|---|---|---|---|---|---|
| Raw material liquid | | Raw | Raw | Raw | Raw | Raw |
| | | material | material | material | material | material |
| | | liquid 1 | liquid 4 | liquid 5 | liquid 6 | liquid 7 |
| Bx of raw material liquid | | 6.1 | 3.5 | 7.1 | 1.4 | 7.3 |
| Primary heating/ | Generation of | present | present | present | present | present |
| diluting step | swirl flow | | | | | |
| | Temperature of | 95° C. | 95° C. | 65° C. | 95° C. | 65° C. |
| | diluting liquid | | | | | |
| | (heated water) | | | | | |
| | Mixing ratio | 1:1 | 1:13 | 1:1 | 1:13 | 1:1 |
| | (diluting liquid/ | | | | | |
| | raw material liquid) | | | | | |
| | Primary heating | 60° C. | 90° C. | 45° C. | 90° C. | 45° C. |
| | temperature (° C.) | | | | | |
| | Bx of mixed liquid | 3.1 | 0.25 | 3.6 | 0.1 | 3.7 |
| | after primary heating | | | | | |
| | Viscosity of mixed | 260 | 0.34 | 480 | 0.32 | 500 |
| | liquid (mPa · s) | | | | | |
| Secondary heating/ | Secondary heating | 130° C. | 130° C. | 130° C. | 130° C. | 130° C. |
| sterilizing step | temperature (° C.) | | | | | |
| | Method of secondary | Plate-type | Plate-type | Plate-type | Plate-type | Plate-type |
| | heating | sterilizer | sterilizer | sterilizer | sterilizer | sterilizer |

### (2) Sensory Evaluation

With regard to Samples 1 and 7 to 10 prepared under the conditions of Table 3, sensory evaluation test was performed for the evaluation items as below under the evaluation condition as presented in Table 4.

### (Evaluation Items)

### (Afterglow of Aroma)

Very proper: A

Proper: B

Heavyish and insufficient: C

Heavy and insufficient: D

(Aroma Felt when Sample is Kept in Mouth)

Very good: A

Good: B

Baddish: C

Bad: D

TABLE 4

| Evaluation condition | Sensory evaluation items | Sample 1 | Sample 7 | Sample 8 | Sample 9 | Sample 10 |
|---|---|---|---|---|---|---|
| When drunk at 5° C. after | Afterglow of aroma | A | B | A | C | A |
| store for 2 weeks at 37° C. | Aroma felt when sample | A | A | B | A | C |
| | is kept in mouth | | | | | |

| | | | | | |
|---|---|---|---|---|---|
| Comprehensive evaluation | A | B | B | C | C |

### (Consideration)

As presented in Table 4, it has been found that the results of the sensory evaluation are obtained that, when the viscosity of the mixed liquid is within a range of 0.33 to 490 mPa*s, the afterglow of aroma and the aroma felt when the sample is kept in the mouth are good.

### Example 3

### Evaluation in Terms of Primary Heating Temperature

### (1) Preparation of Samples

Raw material liquids 1 to 3 were used to prepare Samples 1 and 11 to 16.

TABLE 5

| | | Sample 1 | Sample 11 | Sample 12 | Sample 13 | Sample 14 | Sample 15 | Sample 16 |
|---|---|---|---|---|---|---|---|---|
| Raw material liquid | | Raw | Raw | Raw | Raw | Raw | Raw | Raw |
| | | material | material | material | material | material | material | material |
| | | liquid 1 | liquid 2 | liquid 3 | liquid 1 | liquid 1 | liquid 3 | liquid 1 |
| Bx of raw material liquid | | 6.1 | 15.3 | 42.7 | 6.1 | 6.1 | 42.7 | 6.1 |
| Primary heating/ | Generation of | present | present | present | present | present | present | present |
| diluting step | swirl flow | | | | | | | |
| | Temperature of | 95° C. | 95° C. | 95° C. | 85° C. | 65° C. | 98° C. | 60° C. |
| | diluting liquid | | | | | | | |
| | (heated water) | | | | | | | |
| | Mixing ratio | 1:1 | 1:4 | 1:13 | 1:1 | 1:1 | 1:13 | 1:1 |
| | (diluting liquid/ | | | | | | | |
| | raw material liquid) | | | | | | | |
| | Primary heating | 60° C. | 80° C. | 93° C. | 55° C. | 45° C. | 96° C. | 42° C. |
| | temperature (° C.) | | | | | | | |
| | Bx of mixed liquid | 3.1 | 3.1 | 3.1 | 3.1 | 3.1 | 3.1 | 3.1 |
| | after primary heating | | | | | | | |
| | Viscosity of mixed | 260 | 200 | 178 | 284 | 336 | 170 | 367 |
| | liquid (mPa · s) | | | | | | | |
| Secondary heating/ | Secondary heating | 130° C. | 130° C. | 130° C. | 130° C. | 130° C. | 130° C. | 130° C. |
| sterilizing step | temperature (° C.) | | | | | | | |
| | Method of secondary | Plate-type | Plate-type | Plate-type | Plate-type | Plate-type | Plate-type | Plate-type |
| | heating | sterilizer | sterilizer | sterilizer | sterilizer | sterilizer | sterilizer | sterilizer |

### (2) Sensory Evaluation

With regard to Samples 1 and 11 to 16 prepared under the conditions of Table 5, sensory evaluation test was performed for the evaluation items as below under the evaluation condition as presented in Table 6.

### (Evaluation Items)

### (Savory Aroma)

Very good: A

Good: B

Baddish: C

Bad: D

### (Fresh Aroma)

Very proper: A

Proper: B

Heavyish or insufficient: C

Heavy or insufficient: D

TABLE 6

| Evaluation condition | Sensory evaluation items | Sample 1 | Sample 11 | Sample 12 | Sample 13 | Sample 14 | Sample 15 | Sample 16 |
|---|---|---|---|---|---|---|---|---|
| When drunk at 23° C. after | Savory aroma | A | B | C | A | A | D | A |
| store for 2 weeks at 37° C. | Fresh aroma | A | A | A | B | C | A | D |

| | | | | | | | |
|---|---|---|---|---|---|---|---|
| Comprehensive evaluation | A | B | B | B | B | C | C |

### (Consideration)

As apparent from the presentation in Table 6, results have been obtained that the sensory items of the savory aroma and the fresh aroma are good when the temperature of the mixed liquid in the primary heating/diluting step is within a range of 45° C. to 95° C.

From this fact, it has been revealed that the temperature of the mixed liquid in the primary heating/diluting step has a correlation with these sensory evaluation items.

### Example 4

### Evaluation of Sterilization Holding Temperature in Secondary Heating/Sterilizing Step

### (1) Preparation of Samples

In Sample 1, the holding temperature in the secondary heating/sterilizing step was changed under the conditions as listed in Table 7 to prepare Samples 1 and 17 to 20, and sensory evaluation test was performed for the evaluation items as below.

Table 8 presents results of the sensory evaluation. The method of the sensory evaluation test was the same as in Example 1.

TABLE 7

| | | Sample 1 | Sample 17 | Sample 18 | Sample 19 | Sample 20 |
|---|---|---|---|---|---|---|
| Raw material liquid | | Raw | Raw | Raw | Raw | Raw |
| | | material | material | material | material | material |
| | | liquid 1 | liquid 1 | liquid 1 | liquid 1 | liquid 1 |
| Bx of raw material liquid | | 6.1 | 6.1 | 6.1 | 6.1 | 6.1 |
| Primary heating/ | Generation of | present | present | present | present | present |
| diluting step | swirl flow | | | | | |
| | Temperature of | 95° C. | 95° C. | 95° C. | 95° C. | 95° C. |
| | diluting liquid | | | | | |
| | (heated water) | | | | | |
| | Mixing ratio | 1:1 | 1:1 | 1:1 | 1:1 | 1:1 |
| | (diluting liquid/ | | | | | |
| | raw material liquid) | | | | | |
| | Primary heating | 60° C. | 60° C. | 60° C. | 60° C. | 60° C. |
| | temperature (° C.) | | | | | |
| | Bx of mixed liquid | 3.1 | 3.1 | 3.1 | 3.1 | 3.1 |
| | after primary heating | | | | | |
| | Viscosity of mixed | 260 | 260 | 260 | 260 | 260 |
| | liquid (mPa · s) | | | | | |
| Secondary heating/ | Secondary heating | 130° C. | 140° C. | 125° C. | 123° C. | 142° C. |
| sterilizing step | temperature (° C.) | | | | | |
| | Method of secondary | Plate-type | Plate-type | Plate-type | Plate-type | Plate-type |
| | heating | sterilizer | sterilizer | sterilizer | sterilizer | sterilizer |

### (2) Sensory Evaluation

With regard to Samples 1 and 17 to 20 prepared under the conditions of Table 7, sensory evaluation test was performed for the evaluation items as below under the evaluation condition as presented in Table 8.

### (Evaluation Items)

### (Aroma Felt in Throat)

Very good: A

Good: B

Baddish: C

Bad: D

### (Deliciousness)

Very proper: A

Proper: B

Heavyish or insufficient: C

Heavy or insufficient: D

TABLE 8

| Evaluation condition | Sensory evaluation items | Sample 1 | Sample 17 | Sample 18 | Sample 19 | Sample 20 |
|---|---|---|---|---|---|---|
| When drunk at 5° C. | Aroma felt in throat | A | B | A | A | C |
| | Deliciousness | A | A | B | C | A |

| | | | | | |
|---|---|---|---|---|---|
| Comprehensive evaluation | A | B | B | C | C |

### (Consideration)

As presented in Table 8, it has been found that good results of the sensory evaluation are obtained in view of the aroma felt in the throat and the deliciousness when the holding temperature in the secondary heating/sterilizing step is within a range of 125° C. to 140° C.

### (Conclusion)

As shown in Example 1 to Example 4, it has been found that, according to the method of manufacturing a liquid food/beverage of the present invention, a high-quality green tea beverage packed in a container can be obtained which is excellent in its color, flavor and taste and in which these qualities are unlikely to degrade over time.

### INDUSTRIAL APPLICABILITY

The present invention relates to a method of manufacturing a liquid food/beverage and, in particular, can be applied to a method of manufacturing a liquid food/beverage that has flowability and is obtained by mixing liquid materials having different viscosities.

1. A method of manufacturing a liquid food/beverage packed in a container obtained by diluting a raw material liquid with a diluting liquid having a lower viscosity than that of the raw material liquid, the method comprising:
a diluting liquid heating step of heating the diluting liquid up to a higher temperature than that of the raw material liquid before being mixed with the raw material liquid;
a primary heating/diluting step of swirling the diluting liquid in the raw material liquid to generate a swirl flow thereby to dilute the raw material liquid while heating the raw material liquid through heat convection of the swirl flow; and
a secondary heating/sterilizing step of, after the primary heating/diluting step, heating and sterilizing a mixed liquid of the raw material liquid and the diluting liquid by conductive heat.

2. The method of manufacturing a liquid food/beverage packed in a container as recited in claim 1, wherein the mixed liquid of the raw material liquid and the diluting liquid in the primary heating/diluting step has a viscosity within a range of 0.33 to 490 mPa*s.

3. The method of manufacturing a liquid food/beverage packed in a container as recited in claim 1, wherein the raw material liquid is heated within a range of 45° C. to 95° C. in the primary heating/diluting step.

4. The method of manufacturing a liquid food/beverage packed in a container as recited in claim 1, wherein a sterilizing temperature in the secondary heating/sterilizing step is within a range of 125° C. to 140° C.

5. The method of manufacturing a liquid food/beverage packed in a container as recited in claim 1, wherein the raw material liquid and the diluting liquid are mixed at a constant mass ratio in the primary heating/diluting step.

6. The method of manufacturing a liquid food/beverage packed in a container as recited in claim 1, wherein the raw material liquid contains an extract from a plant body.

7. The method of manufacturing a liquid food/beverage packed in a container as recited in claim 6, wherein the plant body comprises tea leaves.

8. A liquid food/beverage packed in a container manufactured by the method of manufacturing as recited in claim 1.

9. The liquid food/beverage packed in a container as recited in claim 8, wherein the liquid food/beverage packed in a container comprises a green tea beverage packed in a container.

10. A method of preventing time degradation of a liquid food/beverage packed in a container obtained by diluting a raw material liquid with a diluting liquid having a lower viscosity than that of the raw material liquid, the method comprising:
a diluting liquid heating step of heating the diluting liquid up to a higher temperature than that of the raw material liquid before being mixed with the raw material liquid;
a primary heating/diluting step of swirling the diluting liquid in the raw material liquid to generate a swirl flow thereby to dilute the raw material liquid while heating the raw material liquid through heat convection of the swirl flow; and
a secondary heating/sterilizing step of, after the primary heating/diluting step, heating and sterilizing a mixed liquid of the raw material liquid and the diluting liquid.
